(19) United States
(12) Patent Application Publication
(10) Pub. No.: US 2016/0253339 A1
(43) Pub. Date: Sep. 1, 2016

(54) DATA MIGRATION SYSTEMS AND METHODS INCLUDING ARCHIVE MIGRATION

(71) Applicant: BITTITAN, INC., Kirkland, WA (US)

(72) Inventors: Nicholas Arthur Ambrose, Woodinville, WA (US); Vincent Fournier, Seattle, WA (US); Jethro Seghers, Woodinville, WA (US); Geeman Yip, Kirkland, WA (US); James Scott Head, Toronto (CA); Dominic J. Pouzin, Sammamish, WA (US); Cynthia Randriamanohisoa, Savingny Sur Orge (FR)

(73) Assignee: BITTITAN, INC., Kirkland, WA (US)

(21) Appl. No.: 15/055,399

(22) Filed: Feb. 26, 2016

Related U.S. Application Data
(60) Provisional application No. 62/121,340, filed on Feb. 26, 2015.
(60) Provisional application No. 62/191,146, filed on Jul. 10, 2015.

(51) Int. Cl. G06F 17/30; G06F 3/06

(52) U.S. Cl. CPC G06F 17/30079; G06F 17/30182; G06F 17/30138; G06F 3/0608; G06F 3/0647; G06F 3/0689

(57) ABSTRACT

Examples of methods, systems, and computer-readable media for migration of data, including data from archives, are described. In some examples, the archive data may be divided into slices which may be indexed and queried on a per-user basis to facilitate a per-user migration of the archive data. Example techniques are described for migrating archives that employ storage saving techniques. When an extraction fails for lack of a copy of a particular file in a slice, the missing files may be systematically identified and re-processed. Examples are described of methods, systems, and computer-readable media for aggregation of multiple mailbox descriptor files to migrate multiple mailbox descriptor files to a single destination mailbox.

### CROSS REFERENCE TO RELATED APPLICATIONS

This application claims the benefit under 35 U.S.C. §119 of the earlier filing date of U.S. Provisional Application No. 62/121,340 filed Feb. 26, 2015 entitled “DATA MIGRATION SYSTEMS AND METHODS INCLUDING ARCHIVE MIGRATION.”

This application claims the benefit under 35 U.S.C. §119 of the earlier filing date of U.S. Provisional Application No. 62/191,146 filed Jul. 10, 2015, entitled “MULTIPLE MAILBOX DESCRIPTOR FILE AGGREGATION FOR USE IN DATA MIGRATION SYSTEMS AND METHODS WHICH MAY INCLUDE ARCHIVE MIGRATION”.

The aforementioned provisional applications are hereby incorporated by reference in their entirety, for any and all purposes.

### BACKGROUND

Individuals and enterprises store and archive increasing amounts of data, including in on-premises servers. For example, an enterprise may store and maintain large amounts of email correspondence and other data associated with user accounts, often in proprietary archives.

When an enterprise desires to migrate systems by which some or all of their data may be managed (e.g., a change in email system from Microsoft Exchange to Microsoft Office 365), challenges are faced in migrating the stored and archived data in an efficient manner. The archival process may rearrange or reformat the data in a manner that may be difficult or cumbersome to access, and the sheer amount of archived data may make migration complex as traditional operations such as transferring data over a network take prohibitively long.

During the migration of stored and archived data, many enterprises face challenges concerning ensuring the integrity of digital chain of custody manifests or records. Some enterprises use an index of messages in the source archive system to validate the integrity of the destination archive system. Not all source archive systems support interaction with the index of messages. Others interact directly with the source archive system file server to validate the integrity of the destination archive system.

### SUMMARY

Technologies are generally described that include systems and methods. An example method for migrating archived data may include compressing the archived data into compressed files wherein each of the compressed files has at least a first size. Example methods may further include grouping the compressed files into slices, wherein each of the slices has a second size larger than the first size. Example methods may further include indexing the slices to generate an index of the slices, wherein the indexing of the slices occurs at least in part in parallel. Example methods may further include querying the index of the slices in accordance with each user of a plurality of users to extract per-user data sets. Example methods may further include migrating the per-user data sets to a destination system.

Example methods may further include partitioning the compressed files into partitions, wherein each of the partitions has at least a third size larger than the first size and second size. Example methods may further include storing each of the groups on a respective hard drive. Example methods may further include transporting the hard drives to a storage facility. In some example methods, indexing may further include accessing the slices from the storage facility. In some example methods, grouping the compressed files may further include grouping the partitions into slices.

In some example methods, the archived data may further include data selected from the group consisting of emails, tasks, notes, contacts, documents, images, and videos.

In some example methods, grouping the archived data into compressed files may further include compressing a first number of archived data files into a second, smaller number of compressed groups.

In some example methods, the compressed files may be grouped into slices based on at least one criteria selected from the group consisting of a particular time frame, a particular geography, a particular metadata, and a particular user.

Some example methods may further include validating each slice with reference to a chain of custody.

Some example methods may further include generating a bloom filter for each of the slices.

In some example methods, migrating the per-user data sets to a destination system may further include determining whether a file is on a slice using the bloom filter of the slice. In some example methods, migrating the per-user data sets to a destination system may further include migrating the file to the destination system responsive to determining that the file is on the slice.

In some example methods, the archived data may include archived email correspondence. In some example methods, an attachment associated with a plurality of individual email correspondences may be stored in the archived data fewer than the plurality of times. Some example methods may further include maintaining a record of which groups correspond with each of the slices. Some example methods may further include receiving a notification that the attachment was associated with an email correspondence in one of the slices but the attachment was not included in the slice. Some example methods may further include accessing the attachment using the record. Some example methods may further include generating another slice including the email correspondence and the attachment. Some example methods may further include indexing the another slice for inclusion in the index of the slices.

An example method for migrating multiple mailbox descriptor files to a single destination mailbox may include retrieving folders from the multiple mailbox descriptor files. The method may further include aggregating like folders from the multiple mailbox descriptor files into virtual folders. The method may further include migrating the multiple mailbox descriptor files in part by requesting a range of items from one of the virtual folders. The method may further include responsive to a request to get items within a range from the one of the virtual folders, providing operations corresponding to requests to get items from each of the multiple files corresponding to the range within the one of the virtual folders.

In some example methods, providing operations corresponding to requests to get items from each of the multiple files corresponding to the range may include identifying each of the multiple files associated with the request to get items within the range based on a number of items contained within a folder being requested, within each of the multiple files.

Some example methods may further include removing duplicate items from the mailbox descriptor files using an entry ID or a combination of fields to identify duplicates.

In some example methods, the mailbox descriptor file may be in Personal Storage Table format or Off-line Storage Table format.

In some example methods, aggregating like folders from the multiple mailbox descriptor files into virtual folders may include computing an upper bound and a lower bound associated with each of the retrieved folders.

Some example methods may further include sequentially numbering items within the virtual folders using the upper bound and the lower bound associated with each of the retrieved folders.

In some example methods, providing operations corresponding to requests to get items from each of the multiple files corresponding to the range within the one of the virtual folders may include retrieving items from a start folder index at a position of a start index within a start folder through the end of the start folder. In some example methods, providing operations corresponding to requests to get items from each of the multiple files corresponding to the range within the one of the virtual folders may further include retrieving items from an end folder starting with a start of the end folder through a position of the end index within the end folder.

In some example methods, providing operations corresponding to requests to get items from each of the multiple files corresponding to the range within the one of the virtual folders may further include retrieving items from an intermediate folder having indices between the start folder index and the end folder index.

An example method for migrating archived data may include compressing the archived data into compressed files wherein each of the compressed files has a first size. Example methods may further include grouping the compressed files into groups, wherein each of the groups has a second size larger than the first size. Example methods may further include splitting the groups into slices, wherein each of the slices has a third size larger than the first size and smaller than the second size. Example methods may further include indexing the slices to generate an index. Example methods may further include querying the index of the slices in accordance with each user of a plurality of users to extract per-user data sets. Example methods may further include migrating the per-user data sets to a destination system.

An example method may further include generating a bloom filter for each of the slices.

In some examples, migrating the per-user data sets to a destination system may further include determining whether a file is on a slice using the bloom filter of the slice. In some examples, migrating the per-user data sets to a destination system may further include migrating the file to the destination system responsive to determining that the file is on the slice.

The foregoing summary is illustrative only and is not intended to be in an way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1A is an example flowchart for providing on-demand mailbox account migration from a source messaging system to a destination messaging system.

FIG. 1B is an example flowchart for providing on-demand mailbox account synchronization.

FIG. 1C is a schematic illustration of an example architecture for a network and several components.

FIG. 1D is a schematic illustration of a block diagram of a network device.

FIG. 1E is a schematic illustration of a computing system arranged in accordance with examples described herein.

FIG. 2 is a schematic illustration of an example system that may be in use by an enterprise or individual customer.

FIG. 3A is a schematic illustration of a system arranged in accordance with examples described herein.

FIG. 3B is a flow chart illustrating an example method for preparing an archive during a migration.

FIG. 4 is an illustration of a table containing Path, File Name, and File ID fields and populated with rows containing information of files to be migrated in accordance with examples described herein.

FIG. 5 is an illustration of a table containing File ID and Slice ID fields and populated with rows matching a file ID with a slice ID in accordance with examples described herein.

FIG. 6 is an illustration of a table used to monitor the progress of a migration of items 1 through n in accordance with examples described herein.

FIG. 7 is a schematic illustration of a system for migrating multiple mailbox descriptor files in accordance with examples described herein.

FIG. 8 is a schematic illustration of virtual folders arranged in accordance with examples described herein.

FIG. 9 is a schematic illustration of a virtual inbox folder arranged in accordance with examples described herein.

### DETAILED DESCRIPTION

Certain details are set forth below to provide a sufficient understanding of embodiments of the disclosure. However, it will be clear to one skilled in the art that embodiments of the disclosure may be practiced without various aspects of these particular details. In some instances, well-known circuits, control signals, timing protocols, computer system components, and software operations have not been shown in detail in order to avoid unnecessarily obscuring the described embodiments of the disclosure.

Enterprises and/or individuals may desire to migrate data from one computing system to another. Examples of data include, but are not limited to, emails, tasks, notes, contacts, documents, images, videos, or combinations thereof. The data may require manipulation to successfully complete the migration for example, the data may need to be edited and/or rearranged from its format suitable for a source system into a format suitable for a destination system. Any data may generally be migrated, and any system for which a migration (e.g., manipulation of the data from source-accessible format to destination-accessible format) be designed may be used.

Source and destination systems may generally include any type of email or data storage system, including cloud-based systems. Cloud-based systems include those where an individual or enterprise may not host the relevant software or data (e.g., email, data storage, document management) on dedicated servers, but may instead access the functionality through a cloud service provider. Computing resources (e.g., processing unit(s) and electronic storage) may be dynamically allocated to customers based on demand in cloud-based systems.

One or more source systems used by a particular enterprise or individual, may include, but need not be limited to, Microsoft Exchange, Microsoft SharePoint, IBM (formerly Lotus) Notes, or others. Files of the source systems may include files formatted as Personal Storage Table (PST) files (an open proprietary format used by Microsoft for storing items, such as messages), Off-line Storage Tables (OST) files (a format used as a cache by Microsoft Outlook), DOC files (a format used to store documents), and other files. Examples described herein may describe migration of particular files from particular source to particular destination systems, but various data may be migrated using various source and destination systems.

As the enterprise or individual has maintained their data over time, the enterprise or individual may have used a product to maintain archived data. Examples of available products that an enterprise or individual may use to create and/or maintain a data archive include, hut are not limited to, Symantec Enterprise Vault, EMC EmailXtender, EMC SourceOne, and Zantaz Enterprise Archive Solutions (EAS). These archive products typically integrate with the source system servers and capture data flowing through those servers (e.g., emails, documents, or note items) and store the data in an archive.

Examples of methods and systems described herein may be used by enterprises and individuals to migrate data stored in dedicated storage (which dedicated storage may be owned by the enterprise and/or individual) to cloud-based storage, where the amount of storage utilized by the enterprise or individual will be adjusted based on the data required to be stored over time.

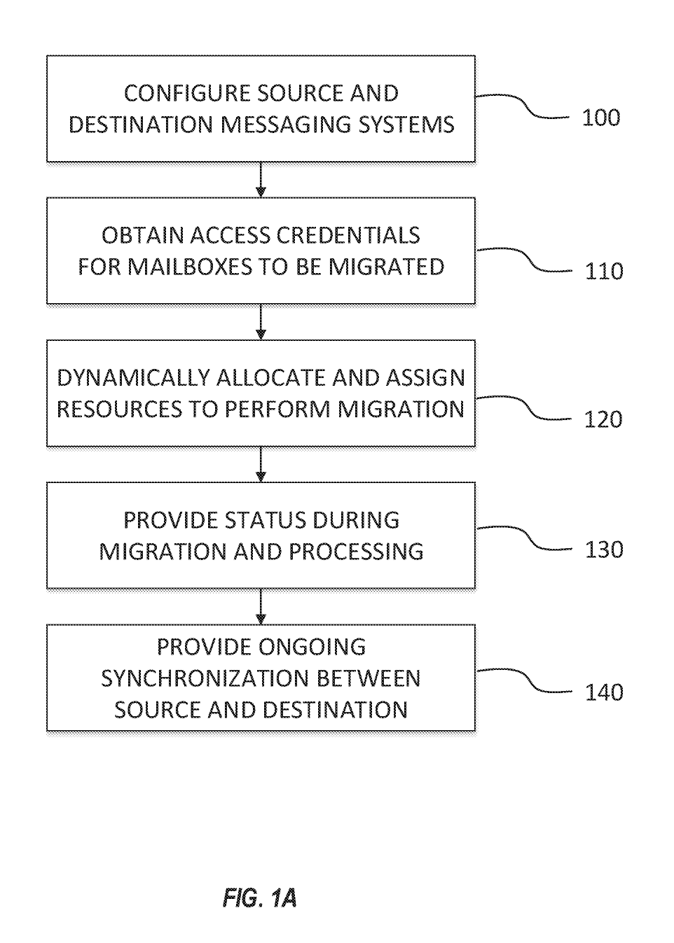

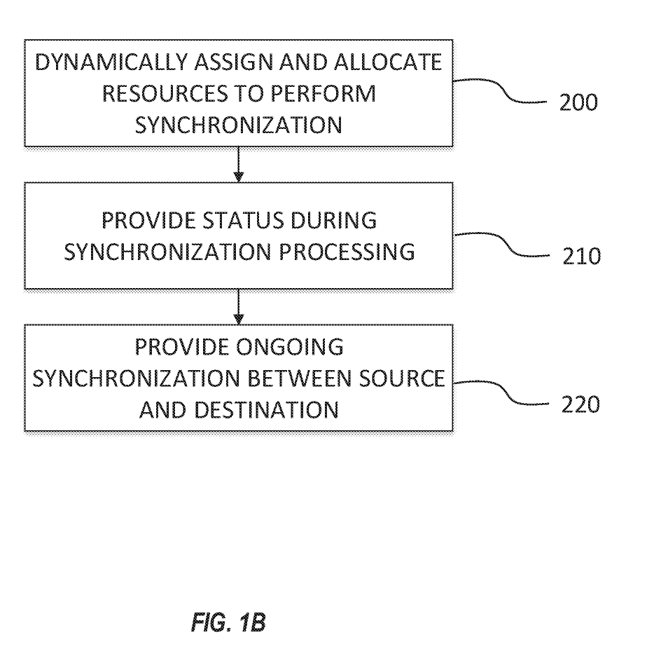

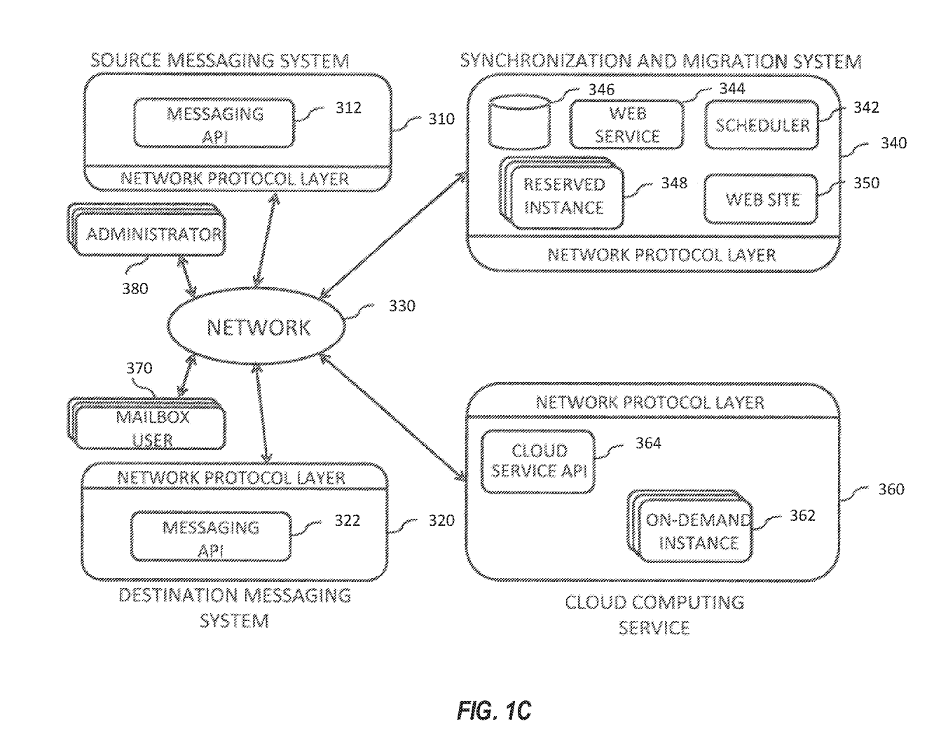

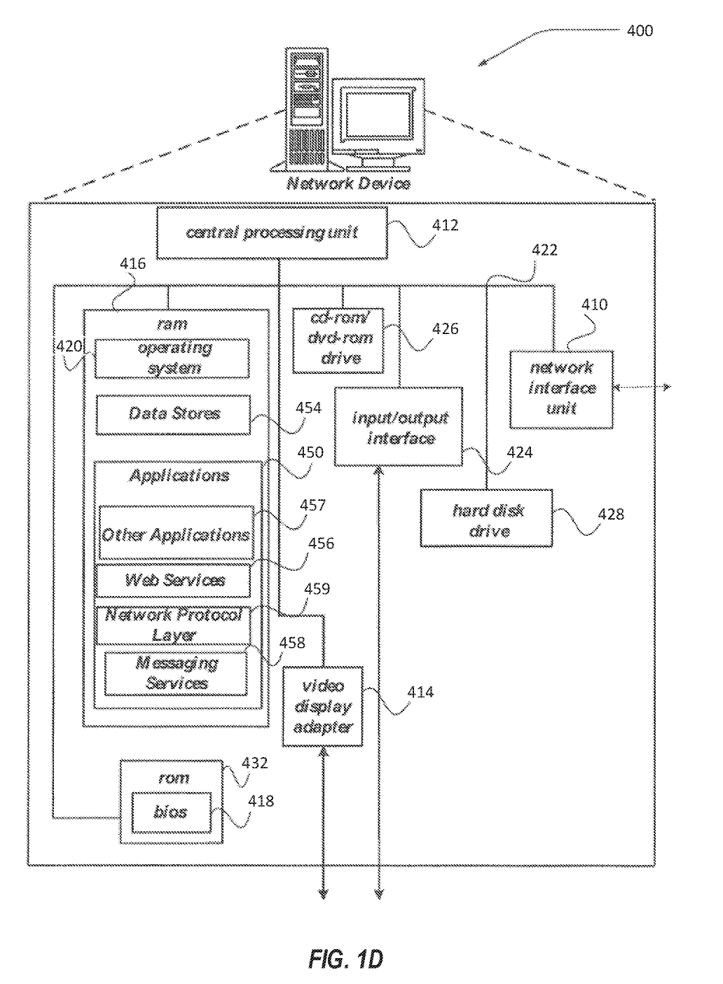

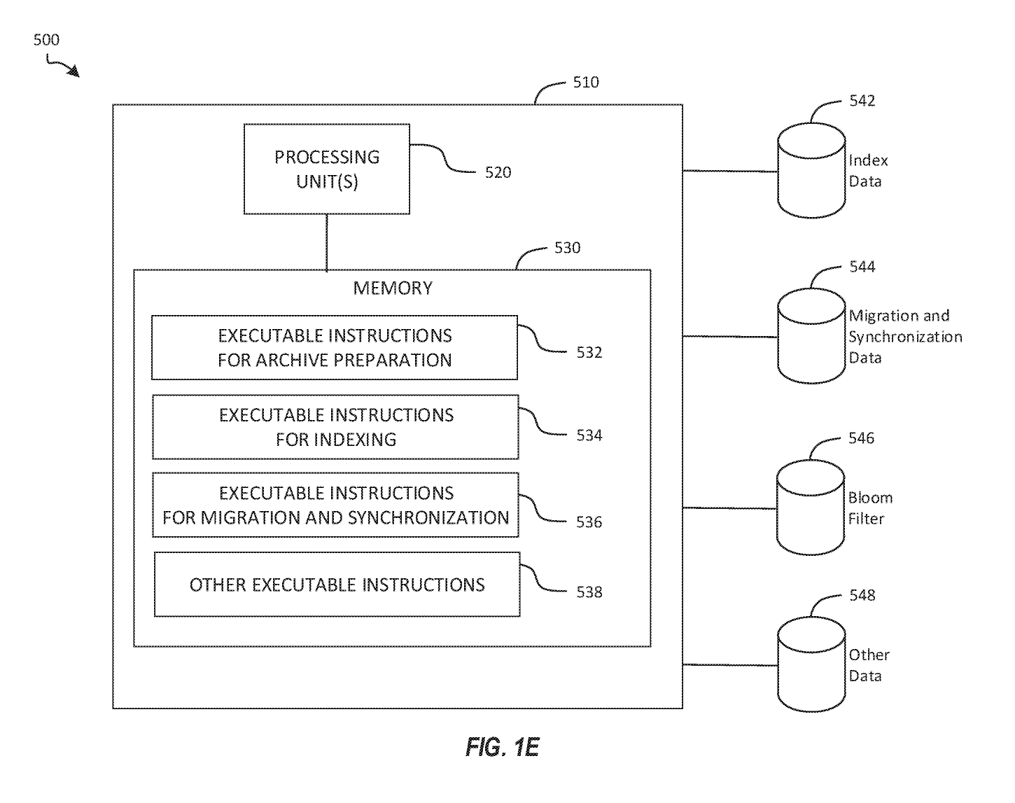

FIG. 1A is a flow chart illustrating a high-level overview of example steps that may provide an on-demand migration from a source system to a destination system. The example method may include one or more operations, functions, or actions as illustrated by one or more of blocks 100, 110, 120, 130, and 140. The operations described in the blocks 110-140 may be performed in response to execution such as by one or more processors described herein) of computer-executable instructions stored in a computer-readable medium, such as a computer-readable medium of a computing device or some other controller similarly configured.

An example process may begin with block 100, which recites “configure source and destination messaging systems.” Block 100 may be followed by block 110, which recites “obtain access credentials for mailboxes to be migrated.” Block 110 may be followed by block 120, which recites “dynamically allocate and assign resources to perform migration.” Block 120 may be followed by block 130, which recites “provide status during migration and processing.” Block 130 may be followed by block 140, which recites “provide ongoing synchronization between source and destination.”

Block 100 recites “configure source and destination messaging systems.” During configuration, information about server location, access credentials, a list of mailboxes to process, and additional processing options may be provided. Block 110 recites “obtain access credentials for mailboxes to be migrated.” This may include, for example, automatically requesting credentials from individual mailbox users. This step need not be required if administrative access to user mailboxes is available, or if mailbox credentials were already specified during configuration (e.g., by the user, an administrator, etc.). Block 120 recites “dynamically allocate and assign resources to perform migration.” If computing resources are insufficient or unavailable, new computing resources may be dynamically allocated. Block 130 recites “provide status during migration and processing.” Status information allows authorized users to monitor mailbox migrations, but also provides information about the availability of, and workload associated with each computing resource. Block 140 recites “provide ongoing synchronization between source and destination.” For example, a migration may provide ongoing synchronization between source and destination messaging systems as an option.

FIG. 1B illustrates a high-level overview of an example process that may be used to provide on-demand synchronization. The example process may include one or more operations, functions, or actions as illustrated by one or more blocks 200, 210, and 220. The operations described in the blocks 200-220 may be performed in response to execution (such as by one or more processors described herein) of computer-executable instructions stored in a computer-readable medium, such as a computer-readable medium of a computing device or some other controller similarly configured.

An example process may begin with block 200, which recites “dynamically assign and allocate resources to perform synchronization.” Block 200 may be followed by block 210, which recites “provide status during synchronization processing.” Block 210 may be followed by block 220, which recites “provide ongoing synchronization between source and destination.”

Block 200 recites “dynamically assign and allocate resources to perform synchronization.” At block 200, mailbox synchronization processing tasks may be dynamically assigned to computing resources. If computing resources are insufficient or unavailable, new computing resources are dynamically allocated. Block 210 recites “provide status during synchronization processing.” At block 210, the process may provide a status during mailbox synchronization processing. Processing status information may allow authorized users to monitor mailbox synchronizations, and may also allow the system to determine the availability of computing resources. Block 220 recites “provide ongoing synchronization between source and destination.” At block 220, the process may provide ongoing synchronization between source and destination messaging systems. Ongoing synchronization may be used to ensure that changes effected to the source or destination mailbox are replicated in a bi-directional manner.

FIG. 1C illustrates a schematic of an example architecture for a network and several components. For example, FIG. 1C illustrates a source messaging system 310 which provides a messaging API 312, and a destination messaging system 320 which provides a messaging API 322. FIG. 1C also illustrates a synchronization and migration system 340 which includes a scheduler 342, a web service 344, a configuration repository 346, one or more reserved instances 348, and a web site 350. FIG. 1C also illustrates a cloud computing service 360 providing access to one or more on-demand instances 362 using a cloud service API 364. FIG. 1C also illustrates one or more mailbox users 370, and one or more administrators 380. FIG. 1C also illustrates a network 330 which is a distributed network such as the Internet. Further, each of the source messaging system 310, the destination messaging system 320, the synchronization and migration system 340, and the cloud computing service 360 may operate on one or more computer devices, or similar apparatuses, with memory, processors, and storage devices. For example, a network device such as described below in conjunction with FIG. 1D may be employed to implement one or more of the source messaging system 310, the destination messaging system 320, the synchronization and migration system 340, and the cloud computing service 360.

The source messaging API 312 and the destination messaging API 322 may be accessible from the network 330. The source messaging API 312 and the destination messaging API 322 typically require authentication, and may implement one or more messaging protocols including but not limited to POP3, IMAP, Delta Sync, MAPI, Gmail, Web DAV, EWS, and other messaging protocols. It should be appreciated that while source and destination roles may remain fixed during migration, they may alternate during synchronization. The synchronization or migration process may include using messaging APIs to copy mailbox content from source to destination, including but not limited to emails, contacts, tasks, appointments, and other content. Additional operations may be performed, including but not limited to checking for duplicates, converting content, creating folders, translating e-mail addresses, and other operations. The synchronization and migration system 340 may manage synchronization and migration resources.

The synchronization and migration system 340 implements the web service 344 and the web site 350, allowing authorized users to submit mailbox processing tasks and monitor their status. Mailbox processing tasks may be referred to as tasks. For programmatic task submission and monitoring, the web service 344 may be more suitable because it implements a programmatic interface. For human-based task submission and monitoring, the web site 350 may more suitable because it implements a graphical user interface in the form of web pages. Before a task can be processed, configuration information about the source messaging system 310 and the destination messaging system 360 may be provided. Additional processing criteria may be specified as well, including but not limited to a list of mailbox object types or folders to process, a date from which processing can start, a specification mapping source and target mailbox folders, a maximum number of mailbox items to process, etc. As will be described in more detail later herein, configuration information may also include administrative or user mailbox credentials. Submitted tasks and configuration information are stored in the configuration repository 346, which may use a persistent location such as a database or files on disk, or a volatile one such as memory.

The synchronization and migration system 340 implements the scheduler 342 which has access to information in the configuration repository 346. The scheduler 342 may be responsible for allocating and managing computing resources to execute tasks. For this purpose, the scheduler 342 may use reserved instances 348, which are well-known physical or virtual computers, typically but not necessarily in the same Intranet. In addition, the scheduler 342 may use the on-demand instances 362, which are physical or virtual computers dynamically obtained from one or more cloud service providers 360, including but not limited to Microsoft Azure from Microsoft Corporation of Redmond, Wash., or Amazon Web Services from Amazon.com, Inc. of Seattle, Wash. Depending on the implementation, reserved instances, on-demand instances, other instances, or a combination thereof may be used.

The scheduler 342 may monitor the status of the instances 348 and 362. To obtain status information, the scheduler 342 may use the cloud service API 364, require the instances 348 and 362 to report their status by calling into web service 346, or connect directly to the instances 348 and 362. Monitored characteristics may include but are not limited to IP address, last response time, geographical location, processing capacity, network capacity, memory load, processor load, network latency, operating system, execution time, processing errors, processing statistics, etc. The scheduler 342 may use part or all of this information to assign tasks to the instances 348 and 362, terminate them, or allocate new ones. A possible implementation of the scheduler 342 will be described later herein.

While the reserved instances 348 may be pre-configured, the on-demand instances 362 may be dynamically allocated, and be configured to run intended binary code using the cloud service API 364. In a possible implementation, the on-demand instances 362 may boot with an initial image, which then downloads and execute binaries from a well-known location such as the web service 344 or the web site 350, but other locations are possible. After being configured to run intended binary code, the instances 348 and 362 may use the web service 346 to periodically retrieve assigned tasks including corresponding configuration information. In other implementations, the scheduler 342 may directly assign tasks by directly communicating with the instances 348 and 362 instead of requiring them to poll. A possible implementation of the instances 348 and 362 will be described later herein.

To facilitate authentication to the messaging systems 310 and 320, an administrator 380 may provide administrative credentials using the web service 344 or the web site 350, which are then stored in the configuration repository 346. Administrative credentials are subsequently transmitted to the instances 348 and 362, allowing them to execute assigned tasks. However, administrative credentials may be unavailable, either because the messaging systems 310 or 340 do not support administrative access, or because administrative credentials are unknown.

To address this issue, the scheduler 342 may automatically contact the mailbox users 370 and request that they submit mailbox credentials. While different types of communication mechanisms are possible, the scheduler may send e-mail messages to the mailbox users 370 requesting that they submit mailbox credentials. This approach may be facilitated by the configuration repository 346 containing a list of source and destination mailboxes, including e-mail addresses. In some implementations, the scheduler 342 may send periodic requests for mailbox credentials until supplied by mailbox users. In some implementations, the scheduler 342 may also include a URL link to the web site 350, allowing mailbox users to securely submit credentials over the network 330. The scheduler 342 may detect when new mailbox credentials have become available, and uses this information to assign executable tasks to the instances 348 and 362.

FIG. 1D shows an embodiment of a network device 400, according to an embodiment. The network device 400 may include many more or less components than those shown. The components shown, however, are sufficient to disclose an illustrative embodiment for practicing the invention. The network device 400 may represent one or more of the source messaging system 310, the destination messaging system 320, the synchronization and migration system 340, and the cloud computing service 360, as described above.

The network device 400 includes the processing unit 412, the video display adapter 414, and a mass memory, all in communication with each other via a bus 422. The mass memory may include RAM 416, ROM 432, and one or more permanent mass storage devices, such as hard disk drive 428, tape drive, optical drive, and/or floppy disk drive. The mass memory may store an operating system 420 for controlling the operation of network device 400. Any general-purpose operating system may be employed. A basic input/output system (“BIOS”) 418 may also be provided for controlling the low-level operation of network device 400. The network device 400 may also communicate with the Internet, or some other communications network, via network interface unit 410, which is constructed for use with various communication protocols including the TCP/IP protocol, and/or through the use of a network protocol layer 459, or the like. The network interface unit 410 is sometimes known as a transceiver, transceiving device, or network interface card (NIC).

The mass memory as described above illustrates another type of computer-readable media, namely computer-readable storage media. Computer-readable storage media (devices) may include volatile, nonvolatile, removable, and non-removable media implemented in any method or technology for storage of information, such as computer readable instructions, data structures, program modules, or other data. Examples of computer readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical, non-transitory medium which can be used to store the desired information and which can be accessed by a computing device.

As shown, data stores 454 may include a database, text, spreadsheet, folder, file, or the like, that may be configured to maintain and store various content. The data stores 454 may also operate as the configuration repository 346 of FIG. 1C, for example. The data stores 454 may further include program code, data, algorithms, and the like, for use by a processor, such as a central processing unit (CPU) 412 to execute and perform actions. In one embodiment, at least some of data and/or instructions stored in the data stores 454 may also be stored on another device of network device 400, including, but not limited to a CD-ROM/DVD-ROM 426, a hard disk drive 428, or other computer-readable storage device resident on the network device 400 or accessible by the network device 400 over, for example, the network interface unit 410.

The mass memory may also store program code and data. One or more applications 450 may be loaded into mass memory and run on the operating system 420. Examples of application programs may include transcoders, schedulers, calendars, database programs, word processing programs, Hypertext Transfer Protocol (HTTP) programs, customizable user interface programs, IPSec applications, encryption programs, security programs, SMS message servers, IM message servers, email servers, account managers, and so forth. The web services 456, the messaging services 458, and the network protocol layer 459, may also be included as application programs within applications 450. However, disclosed embodiments need not be limited to these non-limiting examples, and other applications may also be included.

The messaging services 458 may include virtually any computing component or components configured and arranged to forward messages from message user agents, and/or other message servers, or to deliver messages to a local message store, such as the data store 454, or the like. Thus, the messaging services 458 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, or the like. The messaging services 458 may be configured to manage SMS messages, IM, MMS, IRC, RSS feeds, mIRC, or any of a variety of other message types. In one embodiment, the messaging services 458 may enable users to initiate and/or otherwise conduct chat sessions, VoIP sessions, or the like. The messaging services 458 may further operate to provide a messaging API, such as Messaging API 312 of FIG. 1C.

The web services 456 represent any of a variety of services that are configured to provide content, including messages, over a network to another computing device. Thus, web services 456 include for example, a web server, a File Transfer Protocol (FTP) server, a database server, a content server, or the like. The web services 456 may provide the content including messages over the network using any of a variety of formats, including, but not limited to WAP, HDML, WML, SMGL, HTML, VAL, cHTML, xHTML, or the like. The web services 456 may operate to provide services such as described elsewhere for the web service 344 of FIG. 1C.

The network protocol layer 459 represents those applications useable to provide communications rules and descriptions that enable communications in or between various computing devices. Such protocols, include, but are not limited to signaling, authentication, and error detection and correction capabilities. In one embodiment, at least some of the applications for which the network protocol layer 459 represents may be included within the operating system 420, and/or within the network interface unit 410.

FIG. 1E is a schematic illustration of a computing system 500 arranged in accordance with examples described herein. The computing system 500 includes a computing device 510, which may include as processing unit(s) 520 and memory 530. The memory 530 may be encoded with executable instructions for archive preparation 532, executable instructions for indexing 534, executable instructions for migration and synchronization 536, and/or other executable instructions 538. The computing device 510 may be in communication with electronic storage for index data 542, electronic storage for migration and synchronization 544, electronic storage for a bloom filter 546, and/or other electronic storage 548. In this manner, the computing device 510 may be programmed to (e.g. include processing unit(s) and executable instructions for provide archive preparation, indexing, migration and synchronization, and/or other processes as described herein.

It is to be understood that the arrangement of computing components is flexible. Although shown as contained in a single computing device, in some examples, the processing unit(s) 520 and the memory 530 may be provided on different devices in communication with one another. Although the executable instructions are shown encoded on a same memory, it is to be understood that in other examples a different computer readable media may be used and/or the executable instructions may be provided on multiple computer readable media and/or any of the executable instructions may be distributed across multiple physical media devices. The index data 542, the migration and synchronization data 544, the bloom filter 546, and the other data 548 are shown in separate electronic storage units also separated from the computing device 510. In other examples, one or more of the index data 542, the migration and synchronization data 544, the bloom filter 546, and the other data 548 may be stored in the computing device 510, such as in memory 530 or elsewhere, such as in a device separate from the computing device 510.

Computing device 510 may be implemented using generally any device sufficient to implement and/or execute the systems and methods described herein. The computing device 510 may, for example, be implemented using a computer such as a server, desktop, laptop, tablet, or mobile phone. In some examples, computing device 510 may additionally or instead be implemented using one or more virtual machines. The processing unit(s) 520 may be implemented using one or more processors or other circuitry for performing processing tasks described herein. The memory 530 may be implemented using any suitable electronically accessible memory, including but not limited to RAM, RUM, Flash, SSD, or hard drives. The index data 542, the migration and synchronization data 544, the bloom filter 546, and the other data 548 may be implemented stored on any suitable electronically accessible memory, including but not limited to RAM, RUM, Flash, SSD, or hard drives. Databases may be used to store some or all of the index data 542, the migration and synchronization data 544, the bloom filter 546, and the other data 548

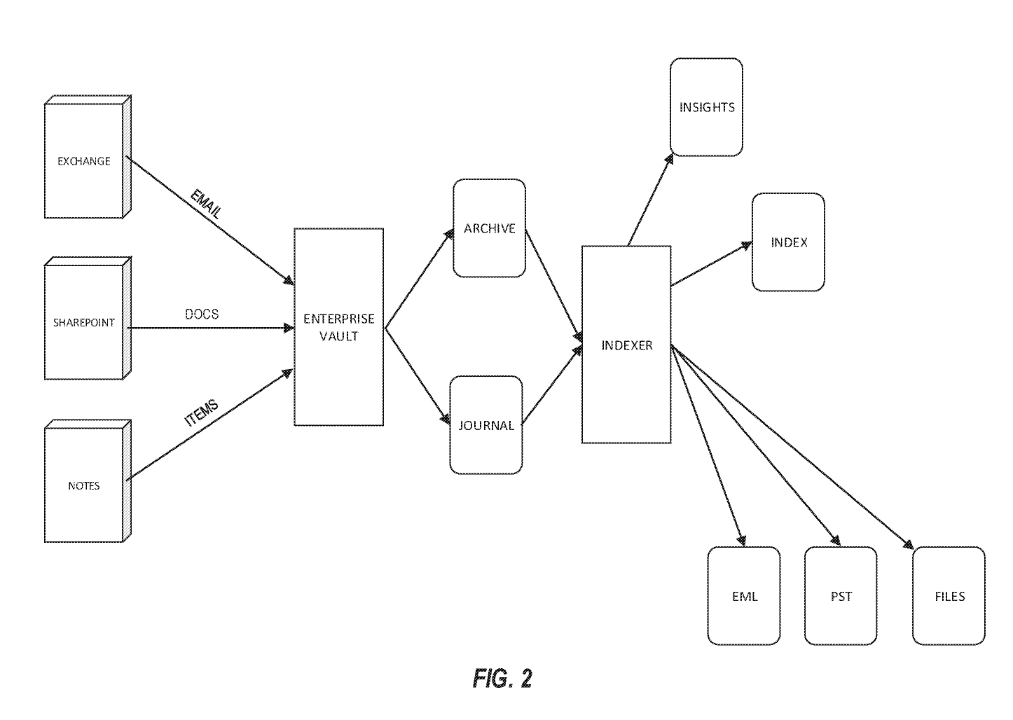

FIG. 2 shows an example system that may be in use by an enterprise or individual customer. The system may include any number of source systems, including only one source system in some examples. In an example, the source system may correspond to a source messaging system 310 as in FIG. 1C. Three source systems are shown in FIG. 2, including a Microsoft Exchange source system, an IBM Notes source system, and a Microsoft SharePoint source system. The customer may utilize an enterprise vault (e.g., a computing system implementing executable instructions for archiving). The enterprise vault may generate an archive and, optionally, a journal, as shown in FIG. 2. The archive and journal are generally proprietary-formatted data stores that are used to archive the data of one or more of the source systems. The archive and journal are logical components of the data stores maintained by the enterprise vault—data making up the archive and journal may be stored on the same or different physical media, and generally any electronic storage media may be used.

The journal may typically be kept for legal compliance reasons. For example, a journal may be used when a specific “legal hold” has been placed on data, or the customer expects one, or some other requirement to retain the data (e.g., the customer may be a government agency or contract for one). Generally, the journal may be invisible to normal users, and they may not be able to interact with it. The journal may record all sent and received (or generated) data where the data cannot be erased by the users or cannot be erased without additional steps. This journal can then be consulted, for example, during a legal case to perform discovery.

The archive may be generated when a customer desires to reduce the amount of storage space consumed on the customer's servers. The customer may utilize slower and cheaper storage for archives, for example. Archives generally hold items for specific users. Those users can generally view and interact with these items. In Exchange, archived items visible to the user are replaced with a “link” to the item in the archive. Other mechanisms of redirecting a user's access of an archived item to the archive may be used in other examples. If a user deletes the item, the item may be removed from their archive but will remain in the journal.

Data (e.g., items) are usually moved to an archive based on a specific company policy all data over 60 days old is archived). Generally, data that may be expected to have less frequent accesses may be moved to the archives such that slower and/or cheaper storage may be used for an archive without as significant of a performance hit for the entire system.

Data stored in the journal and/or archive may be stored in a proprietary format that may be different than a format used before the data was archived. Additionally or instead, data stored in the journal and/or archive may be organized differently than the data was organized prior to processing by the enterprise vault. It may be challenging to migrate this data—for example, the data stored in the journal and/or archive may be large in size (e.g., hundreds of terabytes in some examples). As another example, the data stored in the journal and/or archive may not be as clearly organized by user as the data prior to the archive process.

An indexer may be used to index the data contained in the journal and/or archive. The indexer may be implemented, for example, using a computing device programmed to perform the indexing functions described herein. Generally, the indexer may index and make sense of data (e.g., emails, files, documents), including structured, semi-structured, and unstructured data. Unstructured data may be data that does not already include a uniform mechanism to classify or otherwise query the data. In indexing the data, the indexer may, for example, enable the data to be queried by a user such that all data associated with a particular user may be more readily identified. The indexer may create an index which associates users with data from the journal and/or archive. In this manner, data (e.g., emails, files, documents) may be identified for each user. By making sense of the data, the indexer may produce useful insights into the data.

The indexer may access the data in the journal and/or archive, which may be stored in a proprietary data format. The indexer may index the data in an index. In some examples, data (e.g., items) may be extracted from the journal and/or archive using published APIs; in other examples the data may be accessed directly.

The indexer may export data associated with selected users (or with all users) into respective PST, MSG, and/or EML, files and/or another format that may be utilized by a data migration service (e.g., as may be used by synchronization and migration system 340). In some examples, each mailbox held by a user may be exported into its own PST, MSG, EML, and/or other mailbox descriptor file. Mailbox descriptor files for a same user may be subsequently merged.

It may be possible to conduct a data migration using these output files in some examples, however challenges may exist. The files may be transferred to a cloud provider (e.g., Amazon Web Services or Microsoft Azure) and a final migration of the email to the destination may be performed. However, in some examples due in part to the size of the files to be migrated, the time necessary to transfer the data to a cloud service provider may be undesirable. Moreover, with only a single machine devoted to the migration, the time necessary to conduct the data migration may be undesirably long. With a long migration (e.g., on the order of months or years), extra costs may be spent in operating the source systems and in maintaining the lengthy migration project. Moreover, additional data will likely be generated prior to completion of the migration, and that additional data will also need to be migrated, further lengthening the project. Moreover, transferring files to a cloud provider may require maintaining chain of custody records to comply with legal and other obligations.

Examples of methods and systems described herein may utilize cloud computing and/or parallelism to perform migrations. Migrations may be performed using some or all of the features of the systems and methods of FIGS. 1A-1E. Cloud computing and/or parallelism may increase the speed of a migration, making it feasible to conduct certain migrations which previously would have taken an impermissibly or undesirably long time. Examples may accordingly reduce time and cost involved in migrations, reduce a need to perform as many delta migrations of new data generated prior to completion of the migration, files may be copied from the customer site without interruption to the customer or extra load on the customer servers (once the files are copied) or direct access to customer network needed. Examples of methods and systems described herein may utilize a manifest that indexes or records both or either message indexes and/or files on the source archive system. Examples may accordingly enhance privacy, security, and ease of “self-serve” implementation without requiring custom setup or as much in the way of paid consultants.

The example advantages of example systems and methods are provided herein to facilitate understanding of the described systems and methods. It is to be understood that not all example systems and methods may achieve all, or even any, of the described advantages.

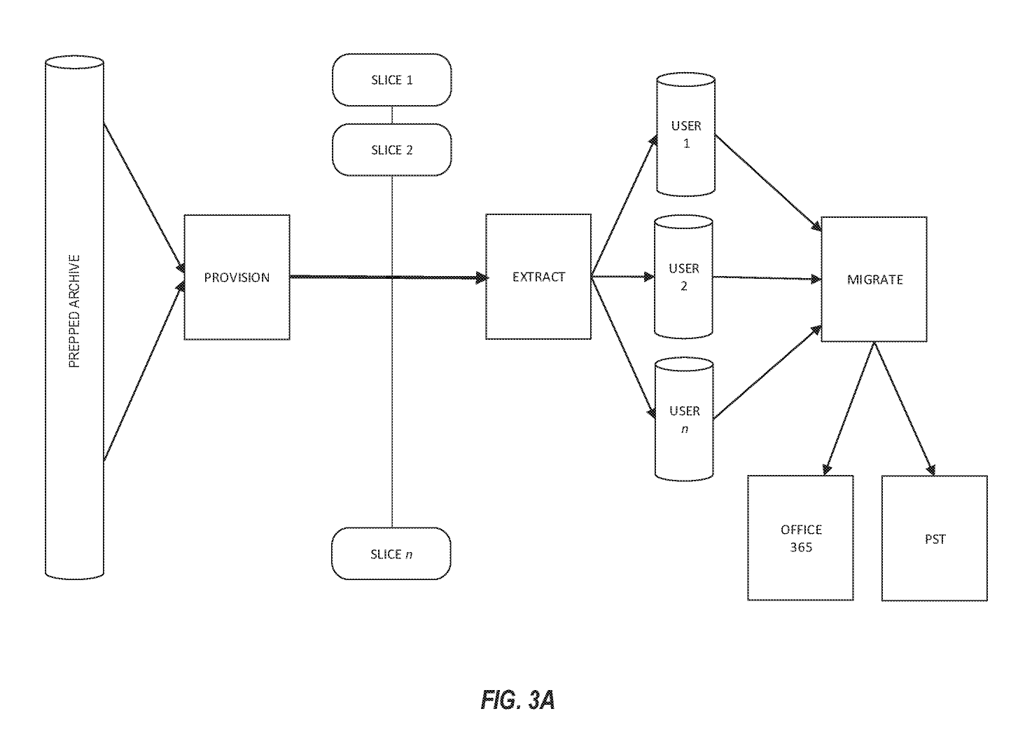

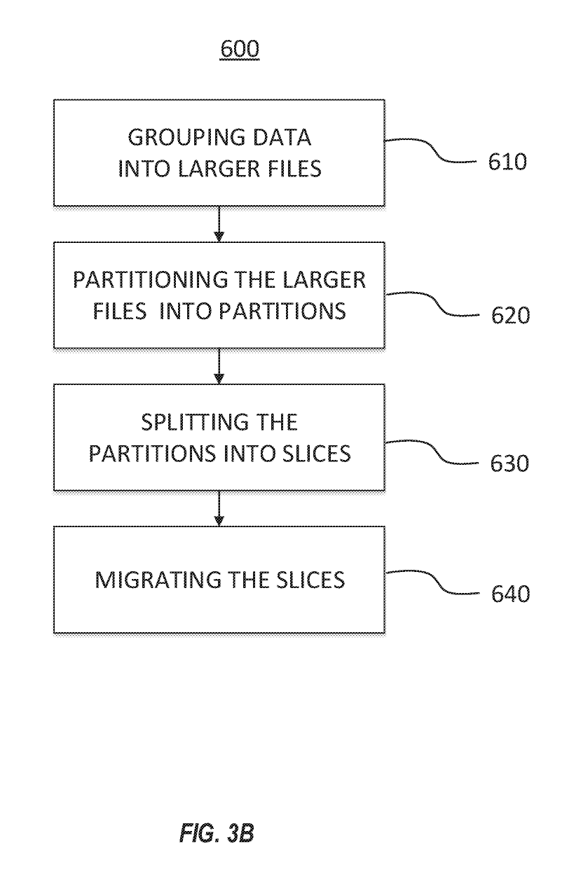

FIG. 3A is a schematic illustration of a system arranged in accordance with examples described herein. The system may include software for provisioning a prepared archive into slices. The software for provisioning may include, for example, executable instructions encoded on one or more computer readable media that, when executed, cause one or more processing units to perform the provisioning acts described herein. The system may further include software for extracting subsets of the data from the slices (e.g., user-specific subsets, as illustrated in FIG. 3A). This may allow software for migration to migrate the data from the extracted subsets (e.g., user-specific subsets) in a parallel fashion (e.g., using dynamically-assigned computing resources from one or more cloud service providers) to a destination server (e.g., Microsoft Office 365) or a destination file format (e.g., PST).

FIG. 3B is a flow chart illustrating an example method 600 including archive preparation. The example method 600 may include one or more operations, functions, or actions as illustrated by one or more of blocks 610, 620, 630, and 640. The operations described in the blocks 610-640 may be performed in response to execution (such as by one or more processors described herein) of computer-executable instructions stored in a computer-readable medium, such as a computer-readable medium of a computing device or some other controller similarly configured. In some examples, archive preparation may be implemented using one or more computing devices programmed with software for archive preparation (e.g., including or capable of accessing computer readable media storing executable instructions for archive preparation).

An example process 600 may begin with block 610, which recites “grouping data into larger files.” Block 610 may be followed by block 620, which recites “partitioning the larger files into partitions.” Block 620 may be followed by block 630, which recites “splitting the partitions into slices.” Block 630 may be followed by block 640, which recites “migrating the slices.”

Block 610 recites “grouping data into larger files.” The archive preparation process may include grouping archive and/or journal files into a smaller number of larger files. The process may compress the grouped data into, for example, a ZIP file. In an example, there may be 1,000 files of 1 MB each stored in an archive and/or journal. The process may zip up the files into 10 files having a size of 100 MB size, each. This may reduce the number of individual files that need to be processed during a migration.

Block 620 recites “partitioning the larger files into partitions.” in some examples, the process may partition the larger files (e.g., compressed files) into larger partitions (e.g., groups). In some examples, the larger partitions are suitable for storage on a physically transportable storage medium (e.g., hard drives). Accordingly, some examples use 4 TB partitions, and a respective hard drive may store each partition. Other examples use 1 TB, 2 TB, 3 TB, 5 TB, 6 TB, 7 TB, 8 TB, or another size partitions. Continuing the example, the process partitions the ten, 100 MB files into two, 500 MB partitions.

The archive preparation process may generate a manifest listing all files (e.g., groups and/or partitions) generated. The partitions including the grouped files (e.g., zipped files) may be copied onto respective transportable media (e.g., hard drives) and may be physically transported (e.g., mailed) to a data center where they may be copied into cloud storage of a cloud-based system. Physically transporting the data in some examples may advantageously avoid a need to copy the data over a network (e.g., the Internet), which may be prohibitively or undesirably slow in some examples. An example of a prepared archive stored at a data center is shown schematically in FIG. 3A (labeled “prepped archive”). Although the term “archive” is shown in FIG. 3A and may be used to describe subsequent actions in the system of FIG. 3A, it is to be understood that the archive shown in FIG. 3A may include or instead be data from a journal as described herein.

Block 630 recites “splitting the partitions into slices.” Software for provisioning the archive (e.g., grouping the archive data into groups, called slices) may be provided in examples described herein. The software may operate to split the archive into slices. A size of the slices may be selected to be greater than a size of the zipped files making up the prepared archive, but less than the amount of the partitions previously defined for delineation into hard drive storage units. Slices may be 200 GB in size in one example. Generally, the size of the slices may be selected in accordance with an amount of data that may be desired for indexing by a process (e.g., indexing software which may be provided by a virtual machine). Continuing the example, the each of the two 500 MB partitions may be split into four 125 MB slices.

The files may be grouped into slices based on various criteria. The slices may represent groups of files corresponding to a particular time frame. For example, there may be a slice that groups all files created in a particular year, month, week, day or other unit of time. The slices may represent groups of files corresponding to a particular geography (e.g., emails from a Seattle office), corresponding to particular metadata emails having an attachment, emails having a flag, or encrypted emails), corresponding to a particular user or user group (e.g., faculty emails), or other criteria. The files may be grouped according to multiple criteria. For example, there may be a slice containing files created at a particular geographic location in a particular month.

To define the slices, the software for provisioning may, but need not, physically move the storage of the data in the prepared archive. The software for provisioning may create database entries describing which of the zipped files are associated with a particular group (e.g., slice). Additionally the file manifest (e.g., storing an association of the files stored inside each of the zipped files) may be uploaded into a database.

Block 640 recites “migrating the slices.” Example systems may include software for extraction. The software for extraction may queue each of the slices for processing. The software for extraction may dynamically assign one or more virtual machines (VMs) to each slice, where the virtual machine may be configured to perform extraction. The VM may include computing resources (e.g., processing unit(s) and memory) which may be allocated to the extraction of a slice at a particular time. In some examples, the number of VMs can be smaller than the number of slices, and so a slice may wait for a VM assignment, and in some examples not all slices may be processed in parallel, although some of the slices may be processed at least in part in parallel, reducing overall processing time relative to the serial processing of all slices.

During the extraction process for a slice, the slice may be copied to the VM. This operation may involve the transfer of the amount of data in the slice (e.g., 200 GB in one example). The amount of data in the slice may not be prohibitive for transfer across a network (e.g., the Internet) and into the cloud for processing by a VM provided by a cloud service provider. An indexer may index and export the slice. The indexing process may, for example, provide per-user data sets e.g., users 1-n shown in FIG. 3A), allowing for per-user migration. The indexing process may create other delineated data sets in some examples, allowing for data migration in accordance with other delineations (e.g., subject matter, date, type of file).

In an example migration, there may be millions of items to be migrated, which are spread across various slices. There may also be a database having a table of items and a table of users. The table of items may have rows of item entries with an ID field and an associated user ID field. The table of users may contain rows of user entries with user ID fields and associated user information.

When processing the example migration, some indexers may take a file-first approach. For example, the indexer may, for each item on a slice, find the user associated with the file and then find the attachments associated with the file using the database.

When processing the example migration, some indexers may take a user-first approach. For example, the indexer may, for each user, find the files associated with the user and associate the user with items.

The export process may generate files in a format which may be readily migrated (e.g., Office 365 and/or PST files in some examples as shown in FIG. 3A). The exported files may be stored in cloud storage in some examples.

The export process may validate each slice with reference to the chain of custody manifest and use error logs to dynamically assign missing files to a slice for processing.

Processing the slices in a parallel manner may reduce an overall time required to process the slices. Moreover, if the process encounters an error, in some examples only the relevant slice (e.g., 200 GB) of data may need to be re-processed, not the entire archive.

Examples of systems described herein include migration software. During the migration process, migration software may migrate data from a source system (e.g., source messaging system 310) to a destination system (e.g., mailboxes in Office 365). In some examples, the source and/or destination system itself may be a cloud-based system. The migration software may also in some examples operate by assigning one or more VMs to the exported files for migration. The migration software may dynamically assign VMs to the tasks of migration, allowing for the dynamic allocation of computing resources to the migration process.

Examples of migration systems and processes are described with regard to FIGS. 1A-1E. Further descriptions of example migration systems, processes, and software are described, for example, in U.S. Pat. No. 8,938,510, issued Jan. 20, 2015 entitled “ON DEMAND MAILBOX SYNCHRONIZATION AND MIGRATION SYSTEM” and U.S. Published Application No. 2014/0149517, published May 29, 2014, entitled “SYSTEMS AND METHODS FOR MIGRATING MAILBOX DATA FROM SYSTEMS WITH LIMITED OR RESTRICTED REMOTE ACCESS” both of which are hereby incorporated by reference herein in their entirety for any purpose. In some examples, the destination system may itself be a cloud-based system, allowing for customers to migrate from an owned software solution (e.g., email system, document storage system) to a cloud-based system.

Examples of systems and methods described herein may allow for migration of data archives and/or journals using parallel processing of slices and indexing to facilitate per-user (or other delineated) migration. Example systems and methods may facilitate the export of data from a proprietary archive format into a more readily migrated format (e.g., PST files).

In some examples, systems and methods described herein may accommodate archives in which data has been reorganized or reduced in an effort to save storage space. For example, some archive systems (e.g., Symantec Enterprise Vault) may store only one copy of certain files (e.g., body of an email, attachment, or document) even though the file may be properly included in multiple archive records.

In other examples, systems and methods described herein may be used to perform delta synchronization migrations for additional archived data stored before the date of any previous migration.

An example of an archive set up to save only one copy of an email attachment even though multiple archived emails may include that attachment is now described. The example is provided to facilitate understanding of the challenges associated with migration of data stored in a streamlined fashion in an archive, and it is to be understood that other example archives may reduce the storage of duplicate files in analogous manners (e.g., storing a file associated with a plurality of archive records such as email correspondence fewer than the plurality of times).

To facilitate understanding of the problem, consider an email sent with an attachment named 1.jpeg. The email may be saved in the archive in a file named, for example, 1.dvs. DVS files are often associated with Symantec Enterprise Vault and contain an item e.g., an email message) and associated metadata. Other file formats may also be used. The archiving software may note the attachment, and generate a fingerprint of the file's contents (e.g., a “hash” function or other compact way to compare the contents of two files without needing the files themselves). For example, SHA1 hashes or MD5 hashes may be used.

For sake of discussion, the fingerprint of the file 1.jpeg may be ABCD. The archiving software may consult its database and determine if any other attachments have the same fingerprint. If the archiving software does not find a match, the attachment is stored. In an example, the archiving software may store the attachments using a single instance part file, which may be named, for example, 1˜1.dvssp. The archiving software may update its database to note that the content for fingerprint ABCD is found inside the file 1˜1.dvssp. In this manner, the archiving software may build a database associating fingerprints with stored file names.

A second email may be intended for archive which is in reply to the original email or otherwise is intended to also include the attachment 1.jpeg. The archiving software may generate a new DVS file, for example 2.dvs. The archiving process will examine the attachment (1.jpeg) and generate the same fingerprint ABCD. However, this time when the archiving process goes to look up the fingerprint in its database, it will find a match. Instead of generating a file 2˜2.dvssp, the archive process database will be updated to note that the attachments for the email stored in 2.dvs can be found in the file 1˜1.dvssp.

In this way, each file (or attachment) may be stored a single time, saving space (the same thing can happen for large email bodies or other files). This however can negatively interfere with the concept of slicing used in examples described herein if the file containing the attachment is not included in the slice containing the email (e.g., if the file 1˜1.dvssp is not included in a slice containing the email 2.dvs). In this situation, a migration process's extractor working on just the slice may not be able to accurately extract the complete email including attachment.

For example, consider a case where the files 1.dvs and 1˜1.dvssp are zipped into the file 1.zip and 2.dvs is zipped into 2.zip. The file 1.zip may be assigned to a first slice, and the file 2.zip may be assigned to a second slice. During migration, the first slice will process accurately, because it includes the 1˜1.dvssp file. However, the second slice may encounter an error because the extracting process may inspect the archiving process database to find any attachments for the file 2.dvs, and the database will indicate the file 1˜1.dvssp has the attachments. But this file will not be present (since it was only in the first slice) and an error will occur. It may not be feasible to detect this situation ahead of time and simply copy the file 1˜1.dvssp to both slices (although it may be done in some examples by inspecting the archive process database).

Examples of systems and methods described herein may generate a record (e.g., a catalog) of all files and their corresponding ZIP files. This record may be stored in cloud storage. Using the archive example discussed above, the catalog may indicate

1.dvs corresponds to 1.zip

1˜1.dvssp corresponds to 1.zip

2.dvs corresponds to 2.zip

Once the data is indexed and processed, the extracting process may provide a notification may that one or more files could not be found (e.g., an attachment was associated with an email but the attachment file was not included in the slice). The extracting process may generate a set of “failed” files. This failed list may include both the name of the file that failed, and the name of the file that was not found.

In this example: 2.dvs, 1˜1.dvssp

Once indexing is complete, the catalog may be consulted to identify the ZIP files associated with the files that extracting process could not find, to generate a set of missing ZIP files. In this example 1.zip would be the missing ZIP file. The missing ZIP files may then be copied to one or more VMs and indexed and extracted in accordance with examples described herein. For example, another slice may be generated containing one or more of the files that failed together with the ZIP files containing the missing files which caused the failures. This slice may then be indexed and extracted to accurately capture the previously failed files.

In this manner, slices may be dynamically updated (e.g., on the VM only, not in the database records) to include the closure of all the files that it references.

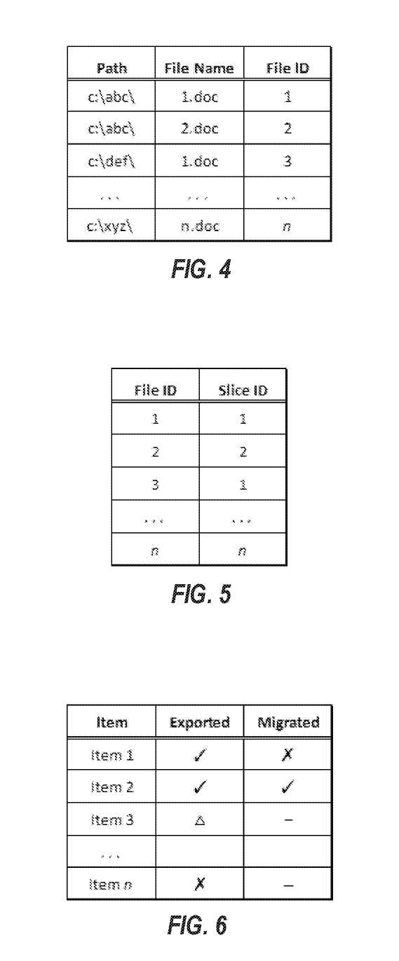

In some examples, a VM may be tasked with migrating a user's items from a particular slice. As part of this process, the VM may determine which of the user's items are or are not located on the particular slice. In some examples, the VM may consult a database to determine whether the particular slice has a particular user item or file (e.g., 1˜1.dvssp). For example the database may include a first and a second table. As shown in FIG. 4, the first table may contain Path, File name, and File ID fields and be populated with rows containing the respective information of the files to be migrated. In some examples, the first and second tables may be stored outside of a chain of custody. As shown in FIG. 5, a second table containing File ID and Slice ID fields may be populated with rows matching a particular file ID with a slice ID. In this manner, given a file's path and name (e.g., a file name on a particular VM or a file name from an index), the VM may retrieve a file ID from the first table. Using the file II), the VM may retrieve a slice II) from the second table. If the slice ID matches the ID of the slice being processed, then the migration continues and the VM processes the file normally because the file is contained within the slice. If the slice ID does not match the ID of the slice being processed, then the process may take a particular action. For example, the process may throw an error may, make a log, or take another action. In some examples, the process does not take any action and the process may ignore the missing file.

In some examples, the process may use a bloom filter (or other similar method) to test whether a file is contained within the particular slice instead of using the database lookup method described above. A bloom filter is a data structure that may be used to determine if an element is not a member of a set. While false positive results are possible, false negative results are not. Advantageously, bloom filters are space efficient. The bloom filter may advantageously allow client-side rather than server-side processing. This is because catalogs and databases containing tables of items, item IDs, and slices are often too large to be stored locally on the VM processing the slice. The space-efficient nature of bloom filters means that the filter may be able to be stored local to the VM processing the slice. This may make the bloom filter method significantly quicker than querying a remote server or database for each item.

The method may begin by creating a bloom filter for each slice. This creates a space-efficient data structure that the migration may use to determine whether a particular file is not located within a slice. The migration may use the bloom filter to test whether the particular file is in the slice quickly without needing to search through the files actually contained within the slice or represented in a database. If the file is not in the slice, then the process may take a particular action. For example, the process may throw an error, make a log, or take other action. In some examples, the process takes no action and the process may ignore the missing file.

Accordingly, for example, a VM or other computing system may migrate items relating to a certain user from a particular slice. The computing system (e.g., a VM) may be provided with a list of items for the user (e.g., generated by an indexing program). The computing system may access and use a bloom filter for the particular slice to determine which items are not included in the slice. For example, the bloom filter may be queried with respect to certain items and the bloom filter may return (or may be used to provide) an indication of which items are not included in the slice. Alternatively or in addition, the bloom filter may return data indicative of which items may possibly be included in the slice. The computing system may then, for each item that the bloom filter indicated may possibly be in the slice, check whether an item is in fact included in the slice (e.g., by accessing tables of a database or other structures storing relationships between slices and items). In this manner, the computing system may not need to check all items as to whether they are included in the slice, because the bloom filter will rule out a number of items. In this manner, database or table accesses may not be required for those items which the bloom filter indicates are definitively not included in the slice.

In some examples, the process may use metadata of the items within a slice to narrow a search space when querying a database, catalog, or other resource. For example, some data stores (such as Symantec Enterprise Vault) may organize data chronologically by year, then month, then day, then by other means. For a given slice, a global date range may be created. The global date range may include the earliest and latest day, month, or year of data within the slice. The process may expand a global date range by a particular amount of time (e.g., a week) in order to provide flexibility to account for potential differences in timekeeping between users (e.g., resulting from time zones, daylight saving time, and other factors). The process may use this global date range may to limit a search space within a database. In some examples, the process uses the names or user IDs of particular uses may to limit a search space. This may be advantageous when, for example, a prospective customer wants to test a migration system on a small number of users. The process may use the names of those particular users to limit the search space.

In some examples, the migration process may use a database, table, or other system may to monitor the progress of a migration from a source to a destination. FIG. 6 illustrates an example table usable for monitoring the progress of a migration of items 1 through n. As illustrated, the migration process is broken into an export and a migration. The table indicates a successful completion of a process with an indicator, such as a flag or other value (the indicator “✓” is shown in FIG. 6). An unsuccessful completion (e.g., due to an error) of a process may be indicated in the table with an indicator, such as a flag or other value (the indicator “ [symbol] ” is shown in FIG. 6). If the process is in progress it may be indicated with an indicator, such as a flag or other value (the indicator “A” is shown in FIG. 6), and if the process has not yet started, then it may be indicated with an indicator, such as a flag or other value (the indicator “-” is shown in FIG. 6). The table may use other symbols or indications. The migration process may use the monitoring of the progress may to provide estimates of time to completion, identify problems in the migration, and for other uses. Errors may indicate that a migration has timed out, an attachment was too large, an item was unable to be extracted from a source archive (e.g., because the file is corrupt) or other errors.

In some examples, the migration process may be documented so as to create a chain of custody showing the process by which the migration took place from the source to the destination. The chain of custody may be started at the customer's premises prior to preparing the archive, journal, or other files. The chain of custody may include information linking a particular file (e.g., as described by its source path and filename) to a particular file ID and the file ID to a particular slice (e.g., as shown and described in reference to FIGS. 4 and 5). The particular files may include documents, emails, files on disk, and other files and/or data.

In some examples, multiple mailbox descriptor files may be associated with a particular user. Generally, mailbox descriptor files may hold information used by email programs and may store information pertaining to email folders, addresses, contact information, email messages, and/or other data. Examples of mailbox descriptor files include, but are not limited to PST files. In some examples, mailbox descriptor files include folder structures for a particular mailbox. One user may be associated with multiple mailbox descriptor files. For example, examples of indexers descried herein may provide multiple PST files corresponding to a single user (e.g., person and/or or email address). Examples described herein may migrate multiple mailbox descriptor files (e.g., multiple PST files) to a single destination mailbox. For example, multiple PST files may be associated with a single project item and migrated together to a single destination. Examples of the migration of multiple PST files to a single destination mailbox may be used in combination with the techniques for migrating archived data described herein, and/or migration of multiple PST files to a single destination mailbox may be performed independent of or without migration of archived data in other examples.

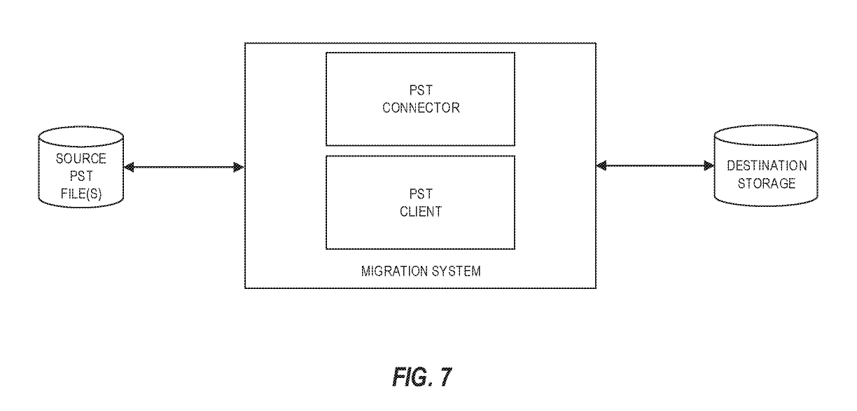

FIG. 7 is a schematic illustration of a system for migrating multiple mailbox descriptor files in accordance with examples described herein. In an example, the system of FIG. 7 may include some or all of the features of the systems and methods of FIGS. 1A-1E (e.g., the source PST file(s) of FIG. 7 may be located on the source messaging system 310). The view in FIG. 7 is conceptual only and not intended to delineate specific storage locations. PST files are discussed with reference to FIG. 7 by way of example, but it is to be understood that other mailbox descriptor files may be migrated additionally or instead in other examples. The system in FIG. 7 schematically includes one or more source PST files, such as the PST files indexed by an indexer and described herein with references to FIGS. 2 and 3. The system schematically includes destination mailbox storage which may or may not be physically separated from a location where the source PST files are stored. In some examples, the PST files may be moved one or more times (e.g., to resources provided by one or more cloud service providers) during the example migration processes described herein. A migration system is also shown in FIG. 7 for migrating the one or more source PST files to the destination storage, where data from multiple PST files may be associated with a single user. The migration system may be implemented, for example, using one or more virtual machines and/or other resources obtained from one or more cloud service providers. General components of the migration system are not shown in FIG. 7, and only selected components are shown which relate to the migration of multiple PST files to a single destination mailbox. A PST connector and PST client are shown, which may be implemented using software (e.g., one or more computer readable media encoded with instructions that may cause an associated one or more processing units, such as one or more processors, to perform the migration actions described herein with reference to those components. Generally, the PST connector may be responsible for downloading PST files and exporting PST items described in those files. The PST client may wrap calls to a library used to read PST files. The PST connector may call the PST client to retrieve PST folders and items.

Multiple mailbox descriptor files associated with a single user may be identified in a variety of ways. For example, a user of the migration system may manually attach multiple PST files to a single migration item (e.g., a user may manually indicate that PST files having paths path1.pst, path2.pst, and path3.pst, should all be migrated to a destination email address of user@example.com). In some examples, the migration system itself may identify that multiple PST files are associated with a single destination address (e.g., by examining characteristics of the PST files, such as a name associated with the PST files). The migration system may include software that includes instructions for using separators to store the multiple PST paths associated with a single destination and escape the separators before serializing the multiple paths to a single string. The system may further include instructions for parsing the string back to the list of paths.

In some examples, a user may have multiple mailboxes associated with a source system, and the PST files may originate from different mailboxes. In this manner, PST folders e.g., multiple PST files) may have more than one PST source. For example, considering three PST files PST1.pst, PST2.pst, and PST3.pst, the folder Inbox may appear in all three. Inbox1 may be used herein to refer to the Inbox in PST1.pst, Inbox2 may be used herein to refer to the inbox in PST2.pst, and Inbox3 may be used herein to refer to the Inbox in PST3.pst, although in each mailbox the Inbox may simply be named Inbox. The three inboxes may share some items, but need not contain the exact same items. Accordingly, the migration system should retrieve folders and items from all PST files to be migrated to a single destination and handle duplicates.

In some examples, the migration system may process the PST files one at a time. The migration system may include instructions for downloading a first PST file of a plurality of PST files to be migrated to a same destination mailbox, retrieving the folders specified in the PST file, retrieving the items in each of the folders, and repeating for each PST file of the plurality to be migrated to a same destination mailbox.

In some examples, the migration system may process multiple PST files using aggregation across folders from different PST files. The migration system may include instructions to download multiple PST files to be migrated to a same destination mailbox (e.g., all PST files to be migrated to a same destination mailbox), retrieve folders from the multiple downloaded PST files, aggregate the folders under virtual views, and process each virtual folder to retrieve items.

The migration system may include instructions from removing duplicate items from multiple PST files to be migrated to a same destination mailbox. For example, entry IDs on the PST items and/or a combination of fields (e.g., size and/or subject) may be used to identify duplicates. The migration system may include instructions for comparing entry IDs and/or a combination of fields associated with items in PST files. If items from two different PST files nonetheless share a same entry ID and/or combination of field values, the migration system may discard one of the files as a duplicate. In some examples, the most recent item of the two items may be retained and migrated while the older item may be discarded (e.g., not migrated).

In examples where the migration system processes multiple PST files using aggregation, the migration system may include instructions for performing a union between the folders in the PST files to retrieve the PST items. A number of PST files per user may be limited by the migration system to avoid storage issues when downloading the multiple PST files. The PST client may include instructions for aggregating folders. The PST client may process each of multiple PST files destined for a particular destination mailbox and may retrieve folders of each of the multiple PST files. During this process, the PST client may build (e.g., store) virtual folders for each distinct folder found (e.g., by folder path). If a folder is encountered in multiple PST files (e.g., Inbox), all instances of this folder path may be aggregated under the same virtual folder. A list of virtual folders may be saved in a storage location accessible to the PST client.

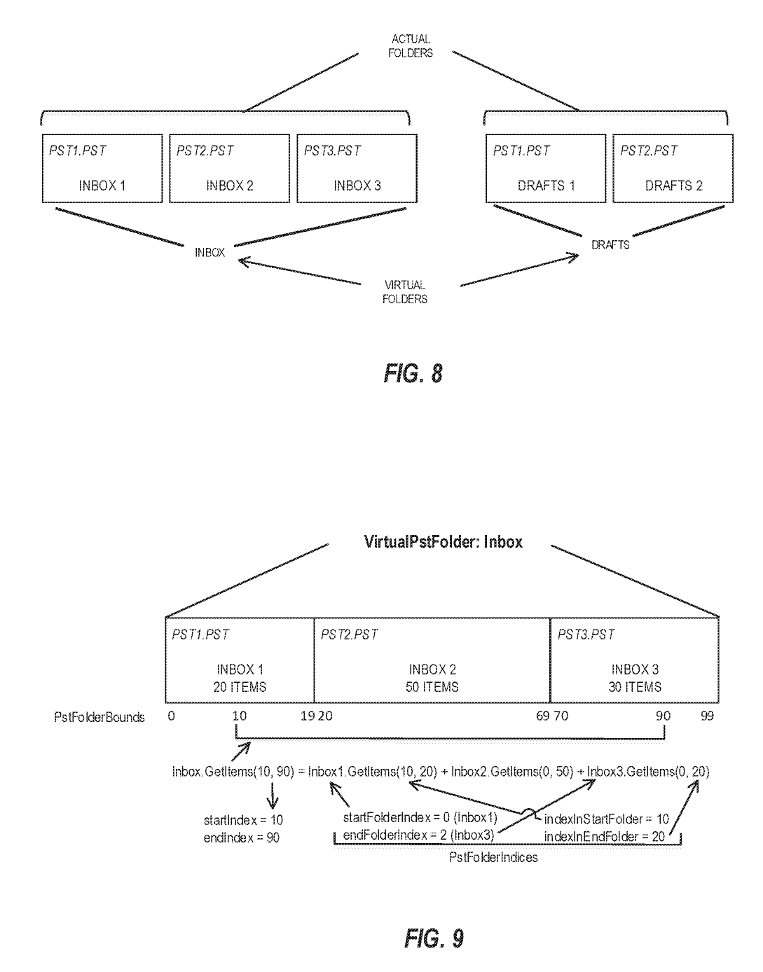

FIG. 8 is a schematic illustration of virtual folders arranged in accordance with examples described herein. Again, PST files are shown and discussed by way of example, but other mailbox descriptor files may additionally or instead be used. An Inbox folder is present in each of files PST1.pst, PST2.pst, and PST3.pst. A Drafts folder is present in PST1.pst and PST2.pst. The PST client may include instructions for associating each of the Inbox folders with a virtual Inbox folder, and each of the Drafts folders with a virtual Drafts folder. The PST client may include instructions for retrieving items by retrieving a virtual folder from a stored list of virtual folders, retrieving the actual folders associated with the virtual folder, and getting the items from each of the actual folders.

Generally, the migration system may include instructions for paging to retrieve items to migrate. Items may be retrieved in batches from folders using example pseudo code such as:

Item[ ] arrayOfPstItems=pstFolder.GetItems(startIndex, endIndex)

This code may, for example, describe returning an array of items from a start index to an end index of a PST folder.

In examples where multiple PST folders are to be aggregated, there may be challenge in retrieving items within a range from multiple PST files. Accordingly, the list of virtual folders may be associated with a list of actual folders associated with the virtual folder, each of which may be assigned an index and a lower and upper bound indicative of a number of items in each folder.

Using the indices and lower and upper bounds, the PST client may determine which items from which files are to be retrieved when receiving an instruction to get items within a particular range from a virtual folder.

FIG. 9 is a schematic illustration of a virtual inbox folder arranged in accordance with examples described herein. The PST client may construct a virtual folder (e.g., VirtualPSTFolder) Inbox which includes the three Inboxes shown in FIG. 8, from PST1.pst, PST2.pst, and PST3.pst. In this example, Inbox1 includes 20 items, Inbox2 includes 50 items, and Inbox3 includes 30 items.

Each of the actual folders associated with a virtual folder may have an index e.g., Inbox1 may have an index 0, Inbox2 may have an index 1, and Inbox3 may have an index 2. The index may be stored in a storage location accessible to the PST client.

The PST client may compute an upper and lower bound (e.g., PSTFolderBounds) associated with each of the actual folders which allow items to be sequentially numbered in the virtual folder and identify a number of items for each actual folder. For example, in FIG. 9, the lower bound for Inbox1 is 0 and the upper bound is 19, reflecting the 20 items in Inbox1. The lower bound for inbox2 is the next sequential number following the upper bound of Inbox 1, 20 in this example, and the upper bound for Inbox2 is 69, reflecting the 50 items in Inbox2 in this example. The lower bound for Inbox3 is the next sequential number after Inbox2, 70 in this example, and the upper bound reflects the number of items in Inbox3 (30 in this example), so the upper bound is 99. The upper and lower bounds may be stored in a storage location accessible to the PST client.

When the PST client receives a request to get items within a particular range from a virtual folder, it may compute indices associated with the request using the upper and lower bounds. For example, if the PST client is requested to obtain items 10-90 of the virtual folder Inbox (e.g., Inbox.GetItems (10,90)), then the PST client may compute folder indices (e.g., PSTFolderIndices) as follows.

A start folder index (e.g., startFolderIndex) of the folder containing a start position of the request (e.g., start index) may be computed. In this example, the start index is 10, which is within the bounds of Inbox1 (e.g., 10 is greater than 0 and less than 19), so the start folder index may be 0.

An end folder index (e.g., endFolderIndex) of the folder containing an end position of the request (e.g., end index) may be computed. In this example, the end index is 90, which is within the bounds of Inbox3 (e.g., 90 is greater than 70 and less than 99), so the end folder index may be 2.

The PST client may compute a position of the start index within the start folder (e.g., indexInStartFolder). In this example, the start folder is Inbox1 and the start index is 10. This start index corresponds to an index of 10 (e.g., item 10 is 10 away from Inbox1's lower bound of 0).

The PST client may compute a position of the end index within the end folder (e.g., indexInEndFolder), in this example, the end folder is Inbox3 and the end index is 90. This end index corresponds to an index of 20 in the end folder (e.g., item 90 is 20 away from Inbox3's lower bound of 70).

In this manner, the PST client may provide a set of operations for each affected PST file on receipt of an instruction to get a range of items from a virtual folder. The migration system may provide the instruction to get a range of items from the virtual folder. Responsive to a request to retrieve a range of items from a virtual folder (e.g., Inbox.GetItems(10,90)), the PST client may provide and/or execute the following requests:

1) Get items from the start folder index starting at a position of the start index within the start folder through the end of the start folder, or to the position of the end index within the end folder if the end folder is also the start folder. For example, Inbox1.GetItems (10,20) in our example.

2) Get all items from any intermediate folders having indices between the start folder index and the end folder index. For example, Inbox2.GetItems (0,50) in our example.

3) Get items from the end folder index starting with a start of the end folder (or the position of the start index within the end folder if the end folder is also the start folder) through the position of the end index within the end folder. For example, Inbox3.GetItems (0,20) in our example.

So, in our example:

Inbox.GetItems(10, 90)=

Inbox1.GetItems(10, 20)+Inbox2.GetItems(0, 50)+Inbox3.GetItems(0, 20)

The PST client may then call each of the operations provided responsive to the request to provide items from a virtual folder. The items may then be migrated according to the various processes and systems described herein.

Various illustrative components, blocks, configurations, modules, and steps have been described above generally in terms of their functionality. Skilled artisans may implement the described functionality in varying ways for each particular application, but such implementation decisions should not be interpreted as causing a departure from the scope of the present disclosure.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be interpreted consistent with the principles and features as previously described.

What is claimed is:

1. A method for migrating archived data, the method comprising:
compressing the archived data into compressed files wherein each of the compressed files has at least a first size;
grouping the compressed files into slices, wherein each of the slices has a second size larger than the first size;
indexing the slices to generate an index of the slices, wherein the indexing of the slices occurs at least in part in parallel;
querying the index of the slices in accordance with each user of a plurality of users to extract per-user data sets; and
migrating the per-user data sets to a destination system.

2. The method of claim 1, further comprising partitioning the compressed files into partitions, wherein each of the partitions has at least a third size larger than the first size and second size;
storing each of the groups on a respective hard drive; and
transporting the hard drives to a storage facility,
wherein the indexing comprises accessing the slices from the storage facility; and
wherein grouping the compressed files comprises grouping the partitions into slices.

3. The method of claim 1, wherein the archived data comprises data selected from the group consisting of emails, tasks, notes, contacts, documents, images, and videos.

4. The method of claim 1, wherein grouping the archived data into compressed files comprises compressing a first number of archived data files into a second, smaller number of compressed groups.

5. The method of claim 1, wherein the compressed files are grouped into slices based on at least one criteria selected from the group consisting of a particular time frame, a particular geography, a particular metadata, and a particular user.

6. The method of claim 1, further comprising validating each slice with reference to a chain of custody.

7. The method of claim 1, further comprising generating a bloom filter for each of the slices.

8. The method of claim 7, wherein migrating the per-user data sets to a destination system further comprises:
determining whether a file is on a slice using the bloom filter of the slice; and
migrating the file to the destination system responsive to determining that the file is on the slice.

9. The method of claim 1, wherein the archived data comprises archived email correspondence and wherein an attachment associated with a plurality of individual email correspondences is stored in the archived data fewer than the plurality of times, the method further comprising:
maintaining a record of which groups correspond with each of the slices;
receiving a notification that the attachment was associated with an email correspondence in one of the slices but the attachment was not included in the slice;
accessing the attachment using the record;
generating another slice including the email correspondence and the attachment; and
indexing the another slice for inclusion in the index of the slices.

10. A method for migrating multiple mailbox descriptor files to a single destination mailbox, the method comprising:
retrieving folders from the multiple mailbox descriptor files;
aggregating like folders from the multiple mailbox descriptor files into virtual folders;
migrating the multiple mailbox descriptor files in part by requesting a range of items from one of the virtual folders;
responsive to a request to get items within a range from the one of the virtual folders, providing operations corresponding to requests to get items from each of the multiple files corresponding to the range within the one of the virtual folders.

11. The method of claim 10, wherein the providing operations corresponding to requests to get items from each of the multiple files corresponding to the range comprises:
identifying each of the multiple files associated with the request to get items within the range based on a number of items contained within a folder being requested, within each of the multiple files.

12. The method of claim 10, further comprising removing duplicate items from the mailbox descriptor files using an entry ID or a combination of fields to identify duplicates.

13. The method of claim 10, wherein the mailbox descriptor file is in Personal Storage Table format or Off-line Storage Table format.

14. The method of claim 10, wherein aggregating like folders from the multiple mailbox descriptor files into virtual folders comprises computing an upper bound and a lower bound associated with each of the retrieved folders.

15. The method of claim 14, further comprising sequentially numbering items within the virtual folders using the upper bound and the lower bound associated with each of the retrieved folders.

16. The method of claim 10, wherein providing operations corresponding to requests to get items from each of the multiple files corresponding to the range within the one of the virtual folders comprises:
retrieving items from a start folder index at a position of a start index within a start folder through the end of the start folder;
retrieving items from an end folder starting with a start of the end folder through a position of the end index within the end folder.

17. The method of claim 16, wherein providing operations corresponding to requests to get items from each of the multiple files corresponding to the range within the one of the virtual folders further comprises:
retrieving items from an intermediate folder having indices between the start folder index and the end folder index.

18. A method for migrating archived data, the method comprising:
compressing the archived data into compressed files wherein each of the compressed files has a first size;
grouping the compressed files into groups, wherein each of the groups has a second size larger than the first size;
splitting the groups into slices, wherein each of the slices has a third size larger than the first size and smaller than the second size;
indexing the slices to generate an index;
querying the index of the slices in accordance with each user of a plurality of users to extract per-user data sets; and
migrating the per-user data sets to a destination system.

19. The method of migrating archived data of claim 18, further comprising generating a bloom filter for each of the slices.

20. The method of migrating archived data of claim 19, wherein migrating the per-user data sets to a destination system further comprises:
determining whether a file is on a slice using the bloom filter of the slice; and
migrating the file to the destination system responsive to determining that the file is on the slice.
